(19) United States
(12) Patent Application Publication
(10) Pub. No.: US 2024/0425085 A1
(43) Pub. Date: Dec. 26, 2024

(54) METHOD FOR CONTENT GENERATION

(71) Applicant: APOLLO INTELLIGENT DRIVING TECHNOLOGY (BEIJING) CO., LTD., BEIJING (CN)

(72) Inventors: Xiaoqing YE, BEIJING (CN); Jizhou HUANG, BEIJING (CN); Fan WANG, BEIJING (CN)

(73) Assignee: APOLLO INTELLIGENT DRIVING TECHNOLOGY (BEIJING) CO., LTD., BEIJING (CN)

(21) Appl. No.: 18/826,345

(22) Filed: Sep. 6, 2024

(30) Foreign Application Priority Data
May 29, 2024 (CN) 202410685130.7

(51) Int. Cl. B60W 60/00; G06V 20/58

(52) U.S. Cl. CPC B60W 60/0027; G06V 20/58

(57) ABSTRACT

A computer-implemented method for content generation is provided. The method includes obtaining first visual data at a specific moment and first control data for controlling content generation, the first visual data including information associated with an environment where a target object is located at the specific moment. The method further includes generating a first feature vector associated with the first visual data. The method further includes generating, based on the first feature vector, a second feature vector under the control of the first control data, the second feature vector including information that characterizes a behavior of the target object in the environment at a subsequent moment after the specific moment.

### CROSS REFERENCE TO RELATED APPLICATION

This application claims priority to Chinese Patent Application No. 202410685130.7 filed on May 29, 2024, the contents of which are hereby incorporated by reference in their entirety for all purposes.

### TECHNICAL FIELD

The present disclosure relates to the technical fields of autonomous driving and artificial intelligence, in particular to the fields of image or video content generation, autonomous driving systems and algorithms, etc., and specifically to a content generation method and apparatus, an electronic device, a computer-readable storage medium, a computer program product, and an autonomous driving vehicle in an end-to-end autonomous driving system.

### BACKGROUND

With the development of autonomous driving technologies in recent years, an autonomous driving system has gradually evolved.

Methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides a content generation method and apparatus, an electronic device, a computer-readable storage medium, a computer program product, and an autonomous driving vehicle in an end-to-end autonomous driving system.

According to an aspect of the present disclosure, there is provided a content generation method, including: obtaining first visual data at a specific moment and first control data for controlling content generation, the first visual data including information associated with an environment where a target object is located at the specific moment; generating a first feature vector associated with the first visual data; and generating, based on the first feature vector, a second feature vector under the control of the first control data, the second feature vector including information that characterizes a behavior of the target object in the environment at a subsequent moment after the specific moment.

According to another aspect of the present disclosure, there is provided an electronic device, including: at least one processor; and a memory communicatively connected to the at least one processor, where the memory stores instructions executable by the at least one processor, and the instructions, when executed by the at least one processor, cause the at least one processor to perform the method described above.

According to another aspect of the present disclosure, there is provided a non-transitory computer-readable storage medium storing computer instructions, where the computer instructions are used to cause a computer to perform the method described above.

It should be understood that the content described in this section is not intended to identify critical or important features of the embodiments of the present disclosure, and is not used to limit the scope of the present disclosure. Other features of the present disclosure will be readily understood with reference to the following description.

### BRIEF DESCRIPTION OF THE DRAWINGS

The accompanying drawings show exemplary embodiments and form a part of the specification, and are used to explain exemplary implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to an embodiment of the present disclosure;

FIG. 2 is a flowchart of a content generation method according to an embodiment of the present disclosure;

FIG. 3 is a schematic diagram of a process of generating a first feature vector according to an embodiment of the present disclosure;

FIG. 4 is a schematic diagram of a process of generating a second feature vector according to an embodiment of the present disclosure;

FIG. 5 is a schematic diagram of a training process of a diffusion transformer according to an embodiment of the present disclosure;

FIG. 6 is a schematic diagram of a process of generating an explanatory text according to an embodiment of the present disclosure;

FIG. 7 is a schematic diagram of a process of generating second visual data according to an embodiment of the present disclosure;

FIG. 8 is a block diagram of a structure of a content generation apparatus according to an embodiment of the present disclosure;

FIG. 9 is a block diagram of a structure of a content generation apparatus according to another embodiment of the present disclosure; and

FIG. 10 is a block diagram of a structure of an example electronic device that can be used to implement an embodiment of the present disclosure.

### DETAILED DESCRIPTION

Exemplary embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one element from the other. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed terms.

The embodiments of the present disclosure will be described below in detail with reference to the accompanying drawings.

FIG. 1 is a schematic diagram of an example system 100 in which various methods and apparatuses described herein can be implemented according to an embodiment of the present disclosure. Referring to FIG. 1, the system 100 includes a motor vehicle 110, a server 120, and one or more communication networks 130 that couple the motor vehicle 110 to the server 120.

In this embodiment of the present disclosure, the motor vehicle 110 may include a computing device according to embodiments of the present disclosure and/or may be configured to perform the method according to embodiments of the present disclosure.

The server 120 may run one or more services or software applications that enable a content generation method according to the embodiments of the present disclosure to be performed. In some embodiments, the server 120 may further provide other services or software applications that may include a non-virtual environment and a virtual environment. In the configuration shown in FIG. 1, the server 120 may include one or more components that implement functions performed by the server 120. These components may include software components, hardware components, or a combination thereof that can be executed by one or more processors. A user of the motor vehicle 110 may sequentially use one or more client applications to interact with the server 120, thereby utilizing the services provided by these components. It should be understood that various different system configurations are possible, and may be different from that of the system 100. Therefore, FIG. 1 is an example of the system for implementing various methods described herein, and is not intended to be limiting.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from the motor vehicle 110. The server 120 may further include one or more applications to display the data feeds and/or real-time events via one or more display devices of the motor vehicle 110.

The network 130 may be any type of network well known to those skilled in the art, and may use any one of a plurality of available protocols (including but not limited to TCP/IP, SNA, IPX, etc.) to support data communication. As a mere example, the one or more networks 130 may be a satellite communication network, a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or Wi-Fi), and/or any combination of these and other networks.

The system 100 may further include one or more databases 150. In some embodiments, these databases can be used to store data and other information. For example, one or more of the databases 150 can be configured to store information such as an audio file and a video file. The database 150 may reside in various locations. For example, the database used by the server 120 may be locally in the server 120, or may be remote from the server 120 and may communicate with the server 120 via a network-based or dedicated connection. The database 150 may be of different types. In some embodiments, the database used by the server 120 may be a database such as a relational database. One or more of these databases can store, update, and retrieve data from or to the database, in response to a command.

In some embodiments, one or more of the databases 150 may also be used by an application to store application data. The database used by the application may be of different types, for example, may be a key-value repository, an object repository, or a regular repository backed by a file system.

The motor vehicle 110 may include a sensor 111 for sensing the surrounding environment. The sensor 111 may include one or more of the following sensors: a visual camera, an infrared camera, an ultrasonic sensor, a millimeter-wave radar, and a lidar (LiDAR). Different sensors can provide different detection precision and ranges. Cameras can be mounted in the front of, at the back of, or at other locations of the vehicle. Visual cameras can capture the situation inside and outside the vehicle in real time and present it to the driver and/or passengers. In addition, by analyzing the image captured by the visual cameras, information such as indications of traffic lights, conditions of crossroads, and operating conditions of other vehicles can be obtained. Infrared cameras can capture objects in night vision. Ultrasonic sensors can be mounted around the vehicle to measure the distances of objects outside the vehicle from the vehicle using characteristics such as the strong ultrasonic directivity. Millimeter-wave radars can be mounted in the front of, at the back of, or at other locations of the vehicle to measure the distances of objects outside the vehicle from the vehicle using the characteristics of electromagnetic waves. Lidars can be mounted in the front of, at the back of, or at other locations of the vehicle to detect edge and shape information of objects, so as to perform object recognition and tracking. Due to the Doppler effect, the radar apparatuses can also measure the velocity changes of vehicles and moving objects.

The motor vehicle 110 may further include a communication apparatus 112. The communication apparatus 112 may include a satellite positioning module that can receive satellite positioning signals (for example, BeiDou, GPS, GLONASS, and GALILEO) from a satellite 141 and generate coordinates based on the signals. The communication apparatus 112 may further include a module for communicating with a mobile communication base station 142. The mobile communication network can implement any suitable communication technology, such as GSM/GPRS, CDMA, LTE, and other current or developing wireless communication technologies (such as 5G technology). The communication apparatus 112 may further have an Internet of Vehicles or vehicle-to-everything (V2X) module, which is configured to implement communication between the vehicle and the outside world, for example, vehicle-to-vehicle (V2V) communication with other vehicles 143 and vehicle-to-infrastructure (V2I) communication with infrastructures 144. In addition, the communication apparatus 112 may further have a module configured to communicate with a user terminal 145 (including but not limited to a smartphone, a tablet computer, or a wearable apparatus such as a watch) by using a wireless local area network or Bluetooth of the IEEE 802.11 standards. With the communication apparatus 112, the motor vehicle 110 may further access the server 120 via the network 130.

The motor vehicle 110 may further include a control apparatus 113. The control apparatus 113 may include a processor that communicates with various types of computer-readable storage apparatuses or media, such as a central processing unit (CPU) or a graphics processing unit (GPU), or other dedicated processors. The control apparatus 113 may include an autonomous driving system for automatically controlling various actuators in the vehicle. The autonomous driving system is configured to control a powertrain, a steering system, a braking system, and the like (not shown) of the motor vehicle 110 via a plurality of actuators in response to inputs from a plurality of sensors 111 or other input devices to control acceleration, steering, and braking, respectively, with no human intervention or with limited human intervention. Part of the processing functions of the control apparatus 113 can be implemented by cloud computing. For example, a vehicle-mounted processor may be used to perform some processing, while cloud computing resources may be used to perform other processing. The control apparatus 113 may be configured to perform the method according to the present disclosure. In addition, the control apparatus 113 may be implemented as an example of a computing device of the motor vehicle (client) according to the present disclosure.

The system 100 of FIG. 1 may be configured and operated in various manners, so that the various methods and apparatuses described according to the present disclosure can be applied.

In the related art, the autonomous driving system has gradually evolved from a classic cascade link structure to an end-to-end solution, where planning and control information may be predicted accordingly from original sensor data. This end-to-end autonomous driving system is still in the exploratory stage and is one of the research hotspots in the industry. Such end-to-end autonomous driving system may be implemented through a single model, which may output planning and control information accordingly after original sensor data is input into the model. However, although cumulative errors that may occur in the cascade link structure can be eliminated by an end-to-end model, the end-to-end model is driven by massive data, which places high requirements on both the quantity and quality of training data. In addition, the prediction of this end-to-end “black box” model provides prediction results based directly on the original sensor data, a process of which lacks proper interpretability, thus posing a challenge to the reliability of the prediction results.

In view of at least one of the above problems, an embodiment of the present disclosure provides a content generation method in an end-to-end autonomous driving system. In the method, content generation can be accurately performed on the basis of conforming to physical laws, thereby facilitating not only generation of a large amount of simulation data for the end-to-end autonomous driving system, but also providing interpretability for the prediction of the end-to-end autonomous driving system.

Aspects of the content generation method according to this embodiment of the present disclosure are described in detail below.

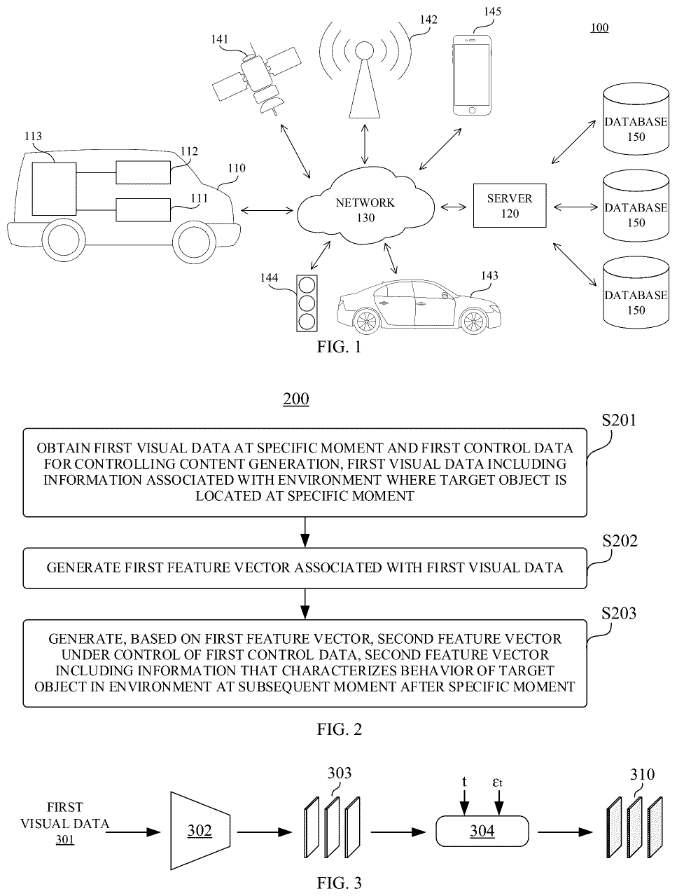

FIG. 2 is a flowchart of a content generation method according to an embodiment of the present disclosure.

As shown in FIG. 2, the content generation method 200 includes steps S201, S202, and S203.

In step S201, first visual data at a specific moment and first control data for controlling content generation are obtained. The first visual data includes information associated with an environment where a target object is located at the specific moment.

In an example, the specific moment may be a moment when the first visual data is acquired or captured. The specific moment may include a current moment and/or a historical moment prior to the current moment. Accordingly, the first visual data may include single frame image data corresponding to the current moment or the historical moment, may include video data corresponding to the current moment and the historical moment, or may include video data corresponding only to the historical moment.

In an example, the target object may include an autonomous driving vehicle (such as the motor vehicle 110 shown in FIG. 1). Accordingly, the first visual data may be acquired or captured by at least one visual sensor provided on the autonomous driving vehicle. The at least one visual sensor can photograph the environment from multiple angles where the autonomous driving vehicle is located, so the obtained first visual data may include information associated with the environment where the autonomous driving vehicle is located at the time of photographing. For example, the autonomous driving vehicle can photograph road and traffic conditions at a distance of several meters away from an intersection ahead, such as a status of traffic lights at the intersection, distribution of roads at the intersection, and traveling statuses of other vehicles ahead and traveling in the same direction. Therefore, the “environment” mentioned herein may refer to a physical world where the target object is located, and the target object may exhibit specific behaviors in the physical world, such as how the autonomous driving vehicle above is going to travel through the intersection ahead from a position several meters away. Therefore, the method may be performed on a pure vision basis, which, compared with a multimodal method such as the fusion of lidar and vision, may provide advantages such as lower costs, higher robustness to bad weather, and suitability for large-scale mass production.

In an example, the first control data may be provided or input externally, which may provide guidance that conforms to physical laws for content generation, so that the method may be performed on the basis of conforming to physical laws. Compared with the general image or video content generation, since the method is applied to autonomous driving scenarios, it has relatively strict requirements on conformity to physical laws and needs to have excellent physical world simulation capabilities, which means that the generated content needs to have higher certainty. Therefore, the introduction of the first control data for controlling content generation may provide a basis for this.

In step S202, a first feature vector associated with the first visual data is generated.

In an example, the first visual data may be derived from the original sensor data, such as an image or a video, but it may increase computational complexity if performing subsequent processing directly on such a pixel space. In view of this, feature extraction may be performed on the first visual data in a specific manner to convert the first visual data into a predetermined feature space, so that the subsequent processing is performed in a form of a feature vector. For example, the first visual data may be converted into a latent space. Accordingly, the first feature vector may carry important image detail information included in the first visual data for the subsequent processing. Therefore, a trade-off between the computational complexity and the image details may be provided by generating the first feature vector associated with the first visual data.

In step S203, a second feature vector is generated based on the first feature vector under the control of the first control data, the second feature vector including information that characterizes a behavior of the target object in the environment at a subsequent moment after the specific moment.

In an example, since the first control data may provide guidance that conforms to physical laws for content generation, the generated second feature vector based on the first feature vector may be constrained by the first control data. That is, the behavior of the target object in the environment at the subsequent moment may have certainty brought by the introduction of the first control data, so that the behavior of the target object conforms to physical laws, thereby achieving simulation of the physical world. In addition, such a content generation process is self-supervised and does not need to rely on additional labeling.

Therefore, given guidance that conforms to physical laws, the method makes it possible to predict, based on an environment where the target object is located at a specific moment, a behavior of the target object in the environment at a subsequent moment after the specific moment, so that such prediction is performed accurately on the basis of conforming to physical laws.

In addition, benefiting from the prediction mechanism used in the method, the method can have an ability to predict for a long time or even an infinite time in the future, that is, autoregression. If first visual data at a specific moment tₖ is given, the behavior of the target object in the environment at a subsequent moment after the specific moment tₖ, such as tₖ₊₁, tₖ₊₂, . . . , and t_{k+N}, may be predicted. If first visual data at a specific moment t_{k+N} is continued to be given, the behavior of the target object in the environment at a subsequent moment after the specific moment t_{k+N}, such as t_{k+N+1}, t_{k+N+2}, . . . , and t_{k+2N}, may continue to be predicted, and so on.

In addition, since the first control data is introduced to provide guidance that conforms to physical laws for prediction in the method, a basis for the interpretability of content generation is provided, which enables an explanation of why such prediction is made.

Moreover, by using the method, as long as first visual data at a specific moment and preset first control data are given, a scenario at a subsequent moment after the specific moment may be simulated, that is, the future may be predicted. This enables the creation of a large amount of diverse simulation data, especially long-tail data that is difficult to be acquired in practice, such as dangerous scenarios where a pedestrian or vehicle suddenly pops out from a blind spot in front (also commonly referred to as “ghost probe”), or where a vehicle in front is leaving things or goods. Therefore, this can facilitate generation of a large amount of simulation data for the end-to-end autonomous driving system.

In addition, by using the method, since essentially the behavior of the target object can already be predicted, a prediction result can accordingly be further used for downstream control and planning tasks, such as determining a position of the target object at a specific subsequent moment after a specific moment, etc. Accordingly, the method can also be applied as a basic model for the end-to-end autonomous driving system to help with downstream tasks.

Aspects of the content generation method according to this embodiment of the present disclosure are described in detail below.

In some embodiments, the first control data may include at least one of the following: an action identifier for indicating the behavior of the target object at the subsequent moment, or additional visual data for indicating at least a portion of the environment associated with the subsequent moment.

In an example, the action identifier is also referred to as an action token, which may include information related to a speed and/or steering wheel angle of the target object (such as the autonomous driving vehicle), to express a traveling trajectory of the autonomous driving vehicle. For example, the action identifier may indicate how the autonomous driving vehicle is going to travel, such as accelerating, decelerating, or changing lanes. Accordingly, under the control of a given action identifier, the generated content may conform to the real physical world and physical laws of the driving scenario.

In an example, the additional visual data may be derived from sensor data from a plurality of viewpoints. For example, the autonomous driving vehicle may be provided with a plurality of visual sensors facing different directions, i.e., a plurality of viewpoints, and the additional visual data may be acquired or captured by some of the plurality of visual sensors. Assuming that the first visual data contains information that there is an intersection in front of the target object, while the additional visual data contains information about an environment related to a left-turning side of the intersection (such as some visual sensors have photographed the left-turning side), which means that the target object may be making or about to start a left turn. That is, the additional visual data may provide more deterministic knowledge for content generation and reduce the degree of freedom of generation. Accordingly, under the control of such additional visual data, elements in the generated content may be consistent with the current scenario, reducing the degree of freedom of generation to have higher certainty.

Therefore, by introducing the action identifier and/or additional visual data as the first control data for controlling content generation, it may be beneficial to provide guidance that conforms to physical laws during the content generation process to achieve simulation of the real world.

In some embodiments, the first control data may be guidance and prompts directly related to the target object. In addition to the first control data, the method may further include second control data related to an additional dynamic object. Accordingly, the step of generating, based on the first feature vector, a second feature vector under the control of the first control data (such as step S203 shown in FIG. 2) may include: modulating the first feature vector by using the second control data to generate a modulated first feature vector, where the second control data is used to indicate a position of the additional dynamic object associated with the target object in the environment at the subsequent moment; and generating, based on the modulated first feature vector, the second feature vector under the control of the first control data.

In an example, the target object may have an associated additional dynamic object in the environment where it is located. As an example of the target object being an autonomous driving vehicle, the additional dynamic object involved in the traveling of the autonomous driving vehicle may include, for example, a vehicle traveling in the same direction in another lane in the same direction, a vehicle traveling in the opposite direction in a lane in the opposite direction, a dynamic obstacle on the road, etc. If such an additional dynamic object is not taken into account during the prediction process, there may be a risk that the prediction result deviates from actual driving rules, such as predicting that the vehicle traveling in the same direction in the another lane in the same direction is driving in reverse. In view of this, the second control data may be further introduced, which is used to indicate the position of the additional dynamic object in the environment at the subsequent moment. Accordingly, such second control data may also be referred to as layout control.

In an example, the modulating of the first feature vector may be represented by the following expression: Zₜ+=Norm(Zₜ)*scale+trans, where Zₜ represents the first feature vector, Zₜ+represents the modulated first feature vector, Norm( ) represents regularization of the content in the brackets, and scale and trans represent a scale parameter an offset parameter used in the modulating, respectively. The scale parameter scale and the offset parameter trans may be determined based on the second control data, that is, the second control data may determine how the first feature vector is to be modulated.

Therefore, by further introducing the second control data related to the additional dynamic object, the dynamic object in the same environment as the target object may be incorporated into the prediction process, so as to facilitate generation of content that conforms to the actual scenario and driving rules.

In some embodiments, the modulating of the first feature vector may be performed via a trained linear network, where the trained linear network may be configured to determine, based on the second control data, parameters for modulating the first feature vector.

In an example, during a training process, the linear network may learn how to determine, based on the second control data, parameters to be used in the modulating, such as the scale parameter scale and the offset parameter trans described above.

Therefore, through pre-training of a linear network for performing a modulation operation, the modulated first feature vector may be obtained simply and quickly based on the second control data, and then a desired second feature vector may be generated under the control of the first control data.

In some embodiments, the second control data may include a detection box indicating the position of the additional dynamic object.

In an example, the detection box may be represented by using coordinates of the four vertices or a coordinate of the center point of the detection box.

In an example, when the linear network is used, during the training process the detection box may be first unified to the same resolution as the first feature vector in the feature space.

Therefore, the position of the additional dynamic object in the same environment as the target object may be accurately located and indicated by using the detection box, which is beneficial for introducing the second control data in a form of a simple signal.

In some embodiments, the step of generating a first feature vector associated with the first visual data (such as step S202 shown in FIG. 2) may include: converting the first visual data into a first latent vector; and adding a noise to the first latent vector to generate the first feature vector.

In an example, the method may be implemented in a latent space based on a diffusion network, such as using the framework of a known latent video diffusion (LVD) model. The first visual data may have an original resolution, and after the feature extraction is performed on the first visual data, the first visual data may be converted into a latent space with a lower resolution than the original resolution, that is, the first latent vector. The latent space may be either high-dimensional or reduced-dimensional.

In an example, based on the principle of a diffusion network, a noise, such as a Gaussian noise, may first be added to the first latent vector. The process of adding a noise to the first latent vector to generate the first feature vector may involve a noise adding process in the diffusion network.

Therefore, by performing the processing of the first visual data in the latent space, the method may be suitable for implementation on the architecture of the diffusion network, and then may benefit from the principle and advantages of the diffusion network to perform self-supervised content generation.

FIG. 3 is a schematic diagram of a process of generating a first feature vector according to an embodiment of the present disclosure.

As shown in FIG. 3, at first, the first visual data 301 may be converted into the first latent vector 303 by an encoder 302. Then, a noise may be added to the first latent vector 303 by a diffusion network 304 (parameters related to the added noise are denoted by t and & in FIG. 3) to generate the first feature vector 310.

It can be understood that, since the specific details of the noise adding process in the diffusion network are known in the art, aspects thereof are not described in detail herein so as not to obscure the gist of the present disclosure.

In an example, the encoder 302 may be a video encoder that may encode one or more image frames, such as an encoder based on a vector quantized generative adversarial network (VQGAN) or variational autoencoder (VAE) architecture.

In an example, the encoder 302 may be trained by using a large number of real videos of autonomous driving as training data. In addition, a corresponding decoder may be trained together with the encoder 302. A reconstruction error (L1 error or L2 error) between an original image and a reconstructed image may be used for training, or a perception error may be used instead of the reconstruction error and an adversarial error may be added for training.

Thus, the first feature vector 310 associated with the first visual data 301 may be generated.

In some embodiments, the step of generating, based on the first feature vector, a second feature vector under the control of the first control data (such as step S203 shown in FIG. 2) may include: denoising the first feature vector under the control of the first control data to generate the second feature vector.

In an example, based on the principle of the diffusion network, a denoising process may be performed after the noise adding process, i.e., content generation or prediction. Therefore, the first feature vector may be denoised under the control of the first control data to generate the second feature vector, so that the generated content or prediction result may conform to physical laws as a result of being guided by the first control data.

It can also be understood that, since the specific details of the denoising process in the diffusion network are known in the art, aspects thereof are not described in detail herein so as not to obscure the gist of the present disclosure.

Therefore, the first control data may be introduced into the denoising process in the diffusion network, so that the generated content or prediction result may be guided by the first control data.

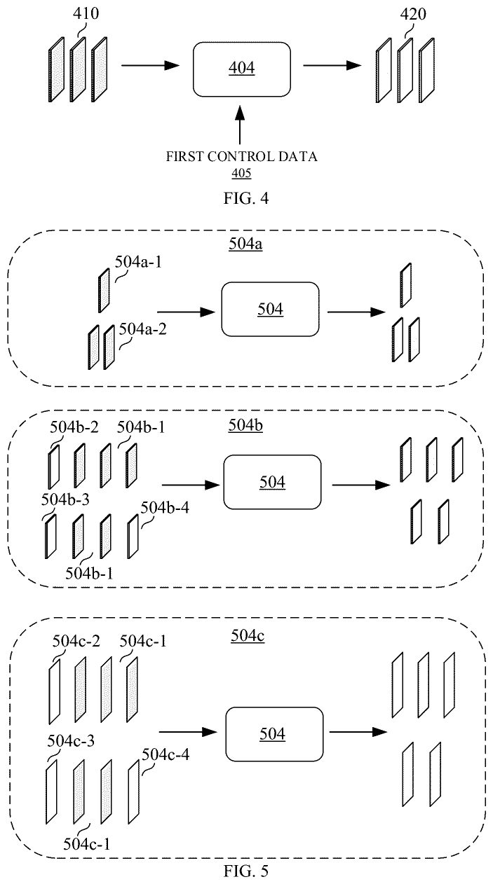

FIG. 4 is a schematic diagram of a process of generating a second feature vector according to an embodiment of the present disclosure.

As shown in FIG. 4, the first feature vector 410 (such as the first feature vector 310 described with reference to FIG. 3) may be input into the diffusion network 404, so as to denoise the first feature vector 410 under the control of first control data 405 to generate the second feature vector 420.

In some embodiments, the denoising of the first feature vector may be performed via a trained diffusion transformer. Training of the diffusion transformer may include at least two stages, training data used in a first stage may include a single sample noise-added feature vector corresponding to a single piece of sample image data and/or a plurality of pieces of first sample noise-added feature vectors corresponding to first sample video data with a frame number less than or equal to a predetermined threshold, and training data used in a remaining stage after the first stage may include a plurality of second sample noise-added feature vectors corresponding to second sample video data with a frame number greater than the predetermined threshold.

In an example, the diffusion transformer may include a stable diffusion transformer.

In an example, the training of the first stage may be performed for content generation based on a single-frame image and/or short time-sequence video, so the training data used in the first stage may include the single sample noise-added feature vector corresponding to the single sample image data (i.e., the single-frame image) and/or the plurality of first sample noise-added feature vectors corresponding to the first sample video data (i.e., the short time-sequence video) with the frame number less than or equal to the predetermined threshold. This stage is to enable the network to learn basic image generation and simple motion inference.

In an example, the training of the remaining stage after the first stage (the remaining stage may further include one or more sub-stages) may be performed for content generation based on a long time-sequence video, so the training data used in the remaining stage may include the plurality of second sample noise-added feature vectors corresponding to the second sample video data (i.e., the long time-sequence video) with the frame number greater than the predetermined threshold. This stage is to enable the network to further improve the clarity and reasonableness of future generation over its basic future imagination capabilities, so as to meet needs such as long-tail data generation and decision simulation.

In autonomous driving scenarios, since the autonomous driving vehicle often photographs images of the environment while in motion, the difference between two adjacent image frames photographed may be significant, which increases the difficulty of predicting the future based on such image frames, and may lead to problems such as slow convergence and susceptibility to crashes during the training process. In view of this, the training process may be performed in several stages, so that the network may gradually learn the ability to solve difficult problems. Therefore, the multi-stage training method described above may provide a more effective training strategy for the diffusion transformer used in the denoising process, so as to avoid the problems such as slow convergence and susceptibility to crashes during the training process, thereby facilitating the obtaining of a diffusion transformer that is more suitable for autonomous driving scenarios.

In some embodiments, the training data used in the remaining stage after the first stage may further include a control feature vector for controlling denoising of the plurality of second sample noise-added feature vectors.

In an example, since the denoising process is essentially used for content generation or prediction, the control feature vector added in the training of the diffusion transformer may play a guiding role in content generation or prediction. That is, the network may be guided by the control feature vector on how to denoise the noise-added feature vector.

Therefore, the diffusion transformer trained by adding the control feature vector can learn how to perform content generation or prediction under given control conditions, and then can accurately perform content generation or prediction under given guidance that conforms to physical laws after the training is completed.

In some embodiments, the control feature vector may include at least one of the following: a sample start frame feature vector corresponding to a sample start frame in the second sample video data, a sample end frame feature vector corresponding to a sample end frame in the second sample video data, or at least one sample intermediate frame feature vector corresponding to at least one sample intermediate frame between the sample start frame and the sample end frame.

In an example, if the sample start frame feature vector and the sample end frame feature vector are used as control feature vectors to guide the denoising of the noise-added feature vector, it can correspond to a video frame interpolation task, that is, the sample start frame feature vector and the sample end frame feature vector are used to tell the network that a content to be generated or a result to be predicted needs to conform to such video start and end content. Similarly, if the sample intermediate frame feature vector is used as the control feature vector to guide the denoising of the noise-added feature vector, the network can then be told that the content to be generated or the result to be predicted needs to conform to such video intermediate content.

Therefore, by using at least one of the sample start frame feature vector, the sample end frame feature vector, or at least one sample intermediate frame feature vector as the control feature vector, the control feature vector may be introduced in a simple way to train the diffusion transformer to learn how to perform content generation or prediction under given control conditions.

In some embodiments, the remaining stage after the first stage may include a second stage and a third stage, and training data used in the third stage may have a higher resolution than training data used in the second stage.

Therefore, the learning ability of the network may be gradually improved by changing the resolution in different stages, further avoiding the problems such as slow convergence and susceptibility to crashes during the training process.

FIG. 5 is a schematic diagram of a training process of a diffusion transformer according to an embodiment of the present disclosure.

As shown in FIG. 5, the training of a diffusion transformer 504 may include a first stage 504a, a second stage 504b, and a third stage 504c.

In the first stage 504a, the training data may include a single first sample noise-added feature vector 504a-1 and a plurality of first sample noise-added feature vectors 504a-2, both of which may have a low resolution.

In the second stage 504b, the training data may include a first training data set that includes a plurality of first sample noise-added feature vectors 504b-1 and a sample intermediate frame feature vector 504b-2, and a second training data set that includes a plurality of first sample noise-added feature vectors 504b-1, a sample start frame feature vector 504b-3, and a sample end frame feature vector 504b-4, all of which may have a low resolution. This stage may use weights obtained by pre-training in the first stage 504a.

In the third stage 504c, the training data may include a third training data set that includes a plurality of second sample noise-added feature vectors 504c-1 and a sample intermediate frame feature vector 504c-2, and a fourth training data set that includes a plurality of second sample noise-added feature vectors 504c-1, a sample start frame feature vector 504c-3, and a sample end frame feature vector 504c-4, all of which may have a high resolution. This stage may use weights obtained by pre-training in the second stage 504b and continue to fine-tune the weights.

In some embodiments, the content generation method (such as the content generation method 200 described in FIG. 2) according to this embodiment of the present disclosure may further include: generating an explanatory text that explains the information contained in the second feature vector.

In an example, the explanatory text may be similar to the chain of thought of a large language model. For example, given a red light scenario a few dozen meters ahead, the prediction result may be that the autonomous driving vehicle slowly approaches the stop line and finally stops basically in front of the stop line, so the explanatory text can provide reasons why such a result is predicted.

In an example, the task of generating the explanatory text may be performed by a text output head that receives the second feature vector.

Therefore, by adding an explanation step, the logic of content generation or prediction may be explained to help determine the reliability of the generated content or prediction result.

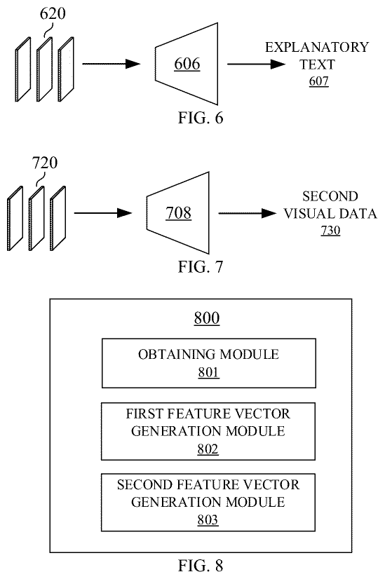

FIG. 6 is a schematic diagram of a process of generating an explanatory text according to an embodiment of the present disclosure.

As shown in FIG. 6, a second feature vector 620 (such as the second feature vector 420 described with reference to FIG. 4) may be provided to a text output head 606 to obtain an explanatory text 607.

In some embodiments, the content generation method (such as the content generation method 200 described in FIG. 2) according to this embodiment of the present disclosure may further include: generating second visual data corresponding to the second feature vector.

In an example, the task of generating the second visual data may be performed by a decoder. The decoder may be obtained by training together with an encoder.

Therefore, further generating the second visual data corresponding to the second feature vector may facilitate creating of a large amount of diverse simulation data by using the method, especially the long-tail data that is difficult to acquire in practice.

FIG. 7 is a schematic diagram of a process of generating second visual data according to an embodiment of the present disclosure.

As shown in FIG. 7, a second feature vector 720 (such as the second feature vector 420 described with reference to FIG. 4, or the second feature vector 620 described with reference to FIG. 6) may be provided to a decoder 708 to obtain second visual data 730.

In an example, the decoder 708 may be a video decoder that may decode a feature vector to reconstruct an image or a video, such as a decoder based on a VQGAN or VAE architecture.

In an example, the decoder 708 may be trained by using a large number of real videos of autonomous driving as training data. In addition, the decoder 708 may be trained together with an encoder (such as the encoder 302 shown in FIG. 3). A reconstruction error (L1 error or L2 error) between an original image and a reconstructed image may be used for training, or a perception error may be used instead of the reconstruction error and an adversarial error may be added for training.

In some embodiments, the first visual data and the second visual data each may include an image or a video.

Therefore, the method may be performed on a pure vision basis, which, compared with a multimodal method such as the fusion of lidar and vision, may provide advantages such as lower costs, higher robustness to bad weather, and suitability for large-scale mass production.

An embodiment of the present disclosure further provides a content generation apparatus in an end-to-end autonomous driving system.

FIG. 8 is a block diagram of a structure of a content generation apparatus 800 according to an embodiment of the present disclosure.

As shown in FIG. 8, the content generation apparatus 800 includes an obtaining module 801, a first feature vector generation module 802, and a second feature vector generation module 803.

The obtaining module 801 is configured to obtain first visual data at a specific moment and first control data for controlling content generation, the first visual data including information associated with an environment where a target object is located at the specific moment.

The first feature vector generation module 802 is configured to generate a first feature vector associated with the first visual data.

The second feature vector generation module 803 is configured to generate, based on the first feature vector, a second feature vector under the control of the first control data, the second feature vector including information that characterizes a behavior of the target object in the environment at a subsequent moment after the specific moment.

Operations of the obtaining module 801, the first feature vector generation module 802, and the second feature vector generation module 803 described above may correspond to steps S201, S202, and S203 as shown in FIG. 2, respectively. Therefore, details of aspects of the operations are omitted here.

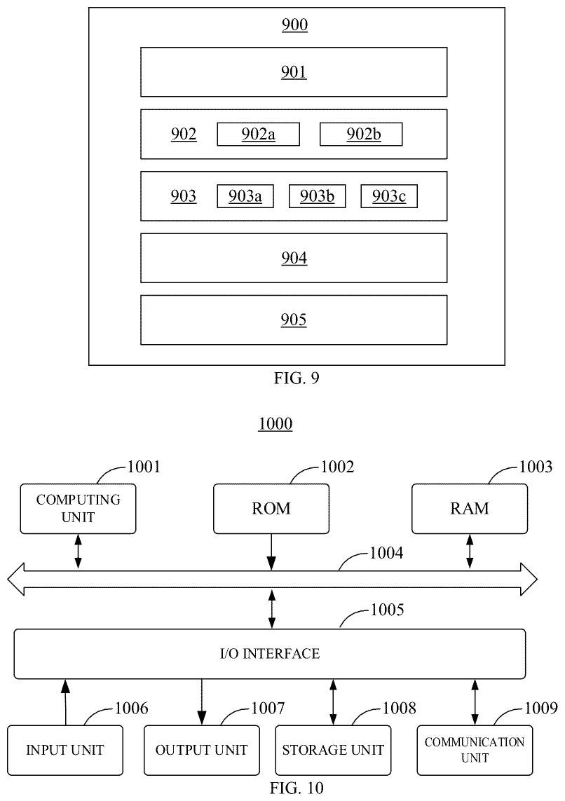

FIG. 9 is a block diagram of a structure of a content generation apparatus 900 according to another embodiment of the present disclosure.

As shown in FIG. 9, the content generation apparatus 900 may include an obtaining module 901, a first feature vector generation module 902, and a second feature vector generation module 903.

Operations of the modules described above may be the same as the operations of the obtaining module 801, the first feature vector generation module 802, and the second feature vector generation module 803 as shown in FIG. 8. In addition, the modules described above may further include further sub-modules.

In some embodiments, the first control data may include at least one of the following: an action identifier for indicating the behavior of the target object at the subsequent moment, or additional visual data for indicating at least a portion of the environment associated with the subsequent moment.

In some embodiments, the second feature vector generation module 903 may include: a modulation module 903a configured to modulate the first feature vector by using the second control data to generate a modulated first feature vector, where the second control data is used to indicate a position of the additional dynamic object associated with the target object in the environment at the subsequent moment; and a generation execution module 903b configured to generate, based on the modulated first feature vector, the second feature vector under the control of the first control data.

In some embodiments, the modulating of the first feature vector may be performed via a trained linear network, where the trained linear network may be configured to determine, based on the second control data, parameters for modulating the first feature vector.

In some embodiments, the second control data may include a detection box indicating the position of the additional dynamic object.

In some embodiments, the first feature vector generation module 902 may include: a conversion module 902a configured to convert the first visual data into a first latent vector; and a noise adding module 902b configured to add a noise to the first latent vector to generate the first feature vector.

In some embodiments, the second feature vector generation module 903 may include: a denoising module 903c configured to denoise the first feature vector under the control of the first control data to generate the second feature vector.

In some embodiments, the denoising of the first feature vector may be performed via a trained diffusion transformer. Training of the diffusion transformer may include at least two stages, training data used in a first stage may include a single sample noise-added feature vector corresponding to a single piece of sample image data and/or a plurality of pieces of first sample noise-added feature vectors corresponding to first sample video data with a frame number less than or equal to a predetermined threshold, and training data used in a remaining stage after the first stage may include a plurality of second sample noise-added feature vectors corresponding to second sample video data with a frame number greater than the predetermined threshold.

In some embodiments, the training data used in the remaining stage after the first stage may further include a control feature vector for controlling denoising of the plurality of second sample noise-added feature vectors.

In some embodiments, the control feature vector may include at least one of the following: a sample start frame feature vector corresponding to a sample start frame in the second sample video data, a sample end frame feature vector corresponding to a sample end frame in the second sample video data, or at least one sample intermediate frame feature vector corresponding to at least one sample intermediate frame between the sample start frame and the sample end frame.

In some embodiments, the remaining stage after the first stage may include a second stage and a third stage, and training data used in the third stage has a higher resolution than training data used in the second stage.

In some embodiments, the content generation apparatus 900 may further include: a text explaining module 904 configured to generate an explanatory text that explains the information contained in the second feature vector.

In some embodiments, the content generation apparatus 900 may further include: a second visual data generation module 905 configured to generate second visual data corresponding to the second feature vector.

In some embodiments, the first visual data and the second visual data each may include an image or a video.

According to an embodiment of the present disclosure, an electronic device is further provided, including at least one processor; and a memory communicatively connected to the at least one processor, where the memory stores instructions executable by the at least one processor, and the instructions, when executed by the at least one processor, cause the at least one processor to perform the method described above.

According to an embodiment of the present disclosure, a non-transitory computer-readable storage medium storing computer instructions is further provided, where the computer instructions are used to cause a computer to perform the method described above.

According to an embodiment of the present disclosure, a computer program product is further provided, including a computer program, where the method described above is implemented when the computer program is executed by a processor.

According to an embodiment of the present disclosure, an autonomous driving vehicle is further provided, the autonomous driving vehicle uses an autonomous driving algorithm, and the autonomous driving algorithm is tested using the method as described above.

In practice, since there may be a case in which the autonomous driving vehicle using a specific autonomous driving algorithm fails, the autonomous driving algorithm may be tested by the content generation method of the embodiments of the present disclosure in this case, such as obtaining a prediction of the future with the help of the method, thereby determining the reasonableness of the autonomous driving algorithm.

Referring to FIG. 10, a block diagram of a structure of an electronic device 1000 that can serve as a server or a client of the present disclosure is now described. The electronic device is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 10, the electronic device 1000 includes a computing unit 1001. The computing unit may perform various appropriate actions and processing according to a computer program stored in a read-only memory (ROM) 1002 or a computer program loaded from a storage unit 1008 to a random access memory (RAM) 1003. The RAM 1003 may further store various programs and data required for the operation of the electronic device 1000. The computing unit 1001, the ROM 1002, and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, an output unit 1007, the storage unit 1008, and a communication unit 1009. The input unit 1006 may be any type of device capable of entering information to the electronic device 1000. The input unit 1006 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 1007 may be any type of device capable of presenting information, and may include, but is not limited to, a display, a speaker, a video/audio output terminal, a vibrator, and/or a printer. The storage unit 1008 may include, but is not limited to, a magnetic disk and an optical disk. The communication unit 1009 allows the electronic device 1000 to exchange information/data with other devices via a computer network such as the Internet and/or various telecommunications networks, and may include, but is not limited to, a modem, a network interface card, an infrared communications device, a wireless communications transceiver, and/or a chipset, for example, a Bluetooth device, an 802.11 device, a Wi-Fi device, a WiMax device, or a cellular communication device.

The computing unit 1001 may be various general-purpose and/or special-purpose processing components with processing and computing capabilities. Some examples of the computing unit 1001 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1001 executes the methods and processing described above. For example, in some embodiments, the method may be implemented as a computer software program, and may be tangibly included in a machine-readable medium, for example, the storage unit 1008. In some embodiments, a part or all of the computer program may be loaded and/or installed onto the electronic device 1000 via the ROM 1002 and/or the communication unit 1009. When the computer program is loaded to the RAM 1003 and executed by the computing unit 1001, one or more steps of the method described above may be performed. Alternatively, in another embodiment, the computing unit 1001 may be configured in any other proper manner (for example, by using firmware) to execute the method described above.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely exemplary embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computer-implemented method for content generation, comprising:
obtaining first visual data at a specific moment and first control data for controlling content generation, wherein the first visual data comprises information associated with an environment where a target object is located at the specific moment;
generating a first feature vector associated with the first visual data; and
generating, based on the first feature vector, a second feature vector under the control of the first control data, wherein the second feature vector comprises information that characterizes a behavior of the target object in the environment at a subsequent moment after the specific moment.

2. The method according to claim 1, wherein the first control data comprises at least one of an action identifier for indicating the behavior of the target object at the subsequent moment, or additional visual data for indicating at least a portion of the environment associated with the subsequent moment.

3. The method according to claim 1, wherein the generating, based on the first feature vector, a second feature vector under the control of the first control data comprises:
modulating the first feature vector by using second control data to generate a modulated first feature vector, wherein the second control data indicates a position of an additional dynamic object associated with the target object in the environment at the subsequent moment; and
generating, based on the modulated first feature vector, the second feature vector under the control of the first control data.

4. The method according to claim 3, wherein the modulating of the first feature vector is performed via a trained linear network, wherein the trained linear network is configured to determine, based on the second control data, parameters for modulating the first feature vector.

5. The method according to claim 3, wherein the second control data comprises a detection box indicating the position of the additional dynamic object.

6. The method according to claim 1, wherein the generating a first feature vector associated with the first visual data comprises:
converting the first visual data into a first latent vector; and
adding a noise to the first latent vector to generate the first feature vector.

7. The method according to claim 6, wherein the generating, based on the first feature vector, a second feature vector under the control of the first control data comprises:
denoising the first feature vector under the control of the first control data to generate the second feature vector.

8. The method according to claim 7, wherein the denoising of the first feature vector is performed via a trained diffusion transformer, and
wherein training of the diffusion transformer comprises at least two stages, and
wherein first training data used in a first stage comprises at least one of a single sample noise-added feature vector corresponding to a single piece of sample image data, or a plurality of pieces of first sample noise-added feature vectors corresponding to first sample video data with a frame number less than or equal to a predetermined threshold, and
wherein second training data used in a remaining stage after the first stage comprises a plurality of second sample noise-added feature vectors corresponding to second sample video data with a frame number greater than the predetermined threshold.

9. The method according to claim 8, wherein the second training data used in the remaining stage after the first stage further comprises a control feature vector for controlling denoising of the plurality of second sample noise-added feature vectors.

10. The method according to claim 9, wherein the control feature vector comprises at least one of a sample start frame feature vector corresponding to a sample start frame in the second sample video data, a sample end frame feature vector corresponding to a sample end frame in the second sample video data, or at least one sample intermediate frame feature vector corresponding to at least one sample intermediate frame between the sample start frame and the sample end frame.

11. The method according to claim 8, wherein the remaining stage after the first stage comprises a second stage and a third stage, and wherein a portion of the second training data used in the third stage has a higher resolution than the other portion of the second training data used in the second stage.

12. The method according to claim 1, further comprising:
generating an explanatory text that explains the information contained in the second feature vector.

13. The method according to claim 1, further comprising:
generating second visual data corresponding to the second feature vector.

14. The method according to claim 13, wherein the first visual data and the second visual data each comprise an image or a video.

15. An electronic device, comprising:
at least one processor; and
a memory communicatively connected to the at least one processor,
wherein the memory stores instructions executable by the at least one processor, and the instructions, when executed by the at least one processor, cause the at least one processor to perform processing comprising:
obtaining first visual data at a specific moment and first control data for controlling content generation, wherein the first visual data comprises information associated with an environment where a target object is located at the specific moment;
generating a first feature vector associated with the first visual data; and
generating, based on the first feature vector, a second feature vector under the control of the first control data, wherein the second feature vector comprises information that characterizes a behavior of the target object in the environment at a subsequent moment after the specific moment.

16. The electronic device according to claim 15, wherein the first control data comprises at least one of an action identifier for indicating the behavior of the target object at the subsequent moment, or additional visual data for indicating at least a portion of the environment associated with the subsequent moment.

17. The electronic device according to claim 15, wherein the generating, based on the first feature vector, a second feature vector under the control of the first control data comprises:
modulating the first feature vector by using second control data to generate a modulated first feature vector, wherein the second control data indicates a position of an additional dynamic object associated with the target object in the environment at the subsequent moment; and
generating, based on the modulated first feature vector, the second feature vector under the control of the first control data.

18. The electronic device according to claim 15, wherein the generating a first feature vector associated with the first visual data comprises:
converting the first visual data into a first latent vector; and
adding a noise to the first latent vector to generate the first feature vector.

19. The electronic device according to claim 15, wherein the processing further comprises:
generating an explanatory text that explains the information contained in the second feature vector.

20. A non-transitory computer-readable storage medium storing computer instructions, wherein the computer instructions are used to cause a computer to perform processing comprising:
obtaining first visual data at a specific moment and first control data for controlling content generation, wherein the first visual data comprises information associated with an environment where a target object is located at the specific moment;
generating a first feature vector associated with the first visual data; and
generating, based on the first feature vector, a second feature vector under the control of the first control data, wherein the second feature vector comprises information that characterizes a behavior of the target object in the environment at a subsequent moment after the specific moment.
